(19) United States
(12) Patent Application Publication
(10) Pub. No.: US 2003/0119380 A1
(43) Pub. Date: Jun. 26, 2003

(54) Electrical connector

(76) Inventor: Hung-Chi Yu, Hsi-Chih (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/104,104

(22) Filed: Mar. 21, 2002

(30) Foreign Application Priority Data
Dec. 26, 2001 (TW) 90223023

(51) Int. Cl. H01R 13/40

(52) U.S. Cl. 439/733.1

(57) ABSTRACT

An electrical connector includes a housing and a plurality of contacts. The housing includes a bottom wall, longitudinal side walls, and end walls extending from peripheral of the bottom walls. A plurality of pin holes defined in the bottom wall and a plurality of ribs alternatively extended over the inner surface of the side walls corresponding to the pin holes. The contact portions of the contacts supported securely by the plateaus and the valleys which defined by the ribs.

### BACKGROUND OF THE INVENTION

1. Field of the Invention

The present invention relates to electrical connectors, and more particularly to an electrical connector having high density contacts and pin holes for transferring more information.

2. Description of the Related Art

With the development of electronic technology and information technology, more and more information is required to transmit between different electronic devices. On the other hand, it is a trend of miniaturization in electronic industry. Therefore, it is desired that an electrical connector used to connect between two electronic devices has a compact configuration.

Referring to FIG. 5, a conventional electrical connector has a housing 100 and a plurality of contacts (not shown). The housing 100 defines a plurality of rectangular pin holes 120 arranged in two rows in opposite sides for receiving the contacts therein. A pitch between two adjacent pin holes is about 0.5 mm. If the pitch is minished, the configuration strength will be reduced and thus the portion between the two adjacent pin holes is brittle. Thus, the amounts of the contacts and the distributing position of the pin hole cannot offer enough information for high-tech products. Furthermore, the pitch of 0.5 mm adversely affects the compact configuration of the electrical connector.

### SUMMARY OF THE INVENTION

Accordingly, an object of the present invention is to provide an electrical connector having high density contacts and pin holes for miniaturization of the electrical connector.

Another object of the present invention is to provide an electrical connector having high density contacts and pin holes for offering enough information for high-tech products.

In order to achieve the above-mentioned object, an electrical connector with the present invention includes a housing and a plurality of contacts. The housing includes a bottom wall, a pair of side walls extending from opposite sides of the bottom wall, and a pair of end walls extending between the side walls. Each side of the bottom wall defines a plurality of stagger pin holes receiving the contacts therein.

Other objects, advantages and novel features of the present invention will be drawn from the following detailed description of preferred embodiments of the present invention with attached drawings, in which:

### BRIEF DESCRIPTION OF THE DRAWINGS

FIG. 1 is an exploded perspective view of an electrical connector in accordance with the present invention;

FIG. 2 is an exploded perspective view of an electrical connector in accordance with a first embodiment of the present invention with a section cut away;

FIG. 3 is an exploded perspective view of an electrical connector in accordance with a second embodiment of the present invention with a section cut away;

FIG. 4 is a perspective view of a housing of an electrical connector in accordance with a further embodiment of the present invention; and

FIG. 5 is a perspective view of a housing of a conventional electrical connector.

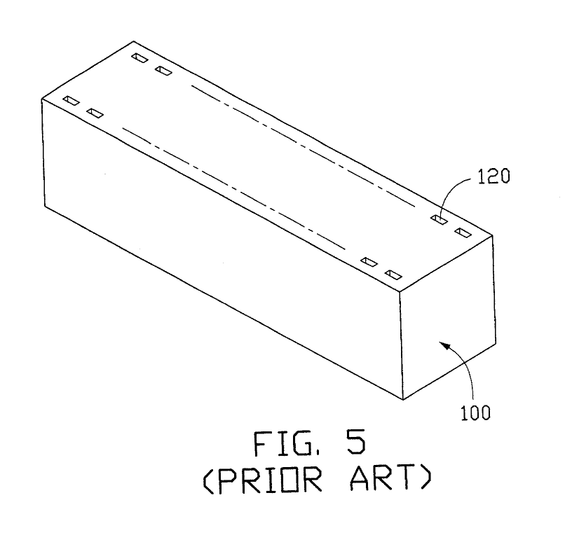

### DETAILED DESCRIPTION OF THE PREFERRED EMBODIMENTS

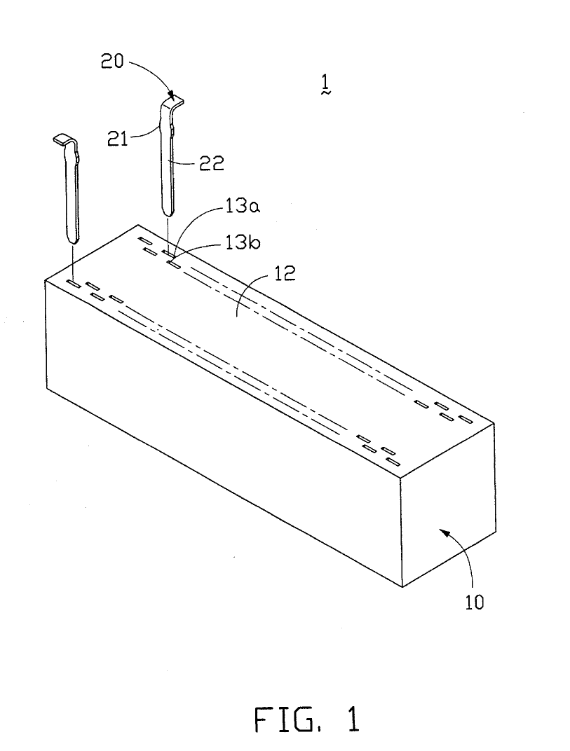

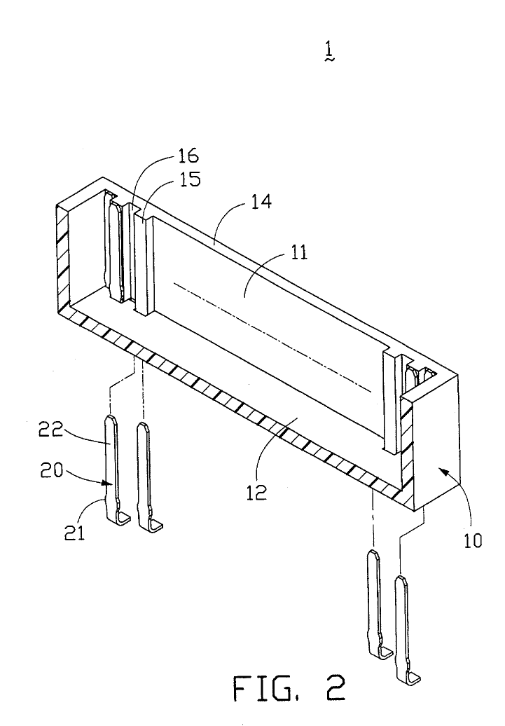

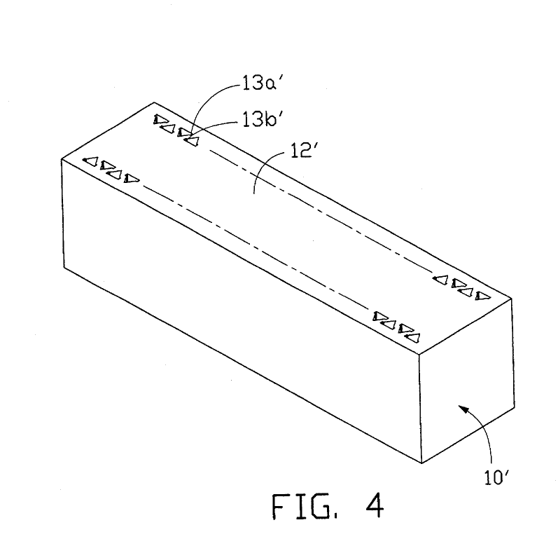

Referring to FIGS. 1 and 2, an electrical connector 1 in accordance with a first embodiment of the present invention includes an insulative housing 10 and a plurality of electrical contacts 20. The housing 10 includes a bottom wall 12, a pair of side walls 14 extending from opposite sides of the bottom wall 12, and a pair of end walls (not labeled) extending from opposite ends of the bottom wall 12 and connected between the side walls 14. Therefore, an elongate receiving slot 11 is defined in the housing 10 for receiving a complementary connector (not shown). Two rows of elongate pin holes 13a, 13b stagger with each other are defined in each side of the bottom wall 12. The pin holes 13a, 13b may be triangular (see FIG. 4) or other shaped. Each side wall 14 forms a plurality of spaced ribs 15 corresponding the pin holes 13b. Therefore, a plurality of spaced recesses 16 is defined in the side wall 14 corresponding to the pin holes 13a.

Each contact 20 includes a securing portion 21 engagingly received in the corresponding pin hole 13a or 13b, and a mating portion 22 extending from the securing portion 21. The contacts extending through the pin holes 13a are received in the recesses 16 and abut against the side wall 14. The contacts extending through the pin holes 13b abut against the ribs 15 of the side wall 14. Thus, the pin holes 13a, 13b and contacts 20 are compact thereby maximizing the capacity of information transmission of the connector 1. Furthermore, the configuration of the electrical connector 1 is miniaturized.

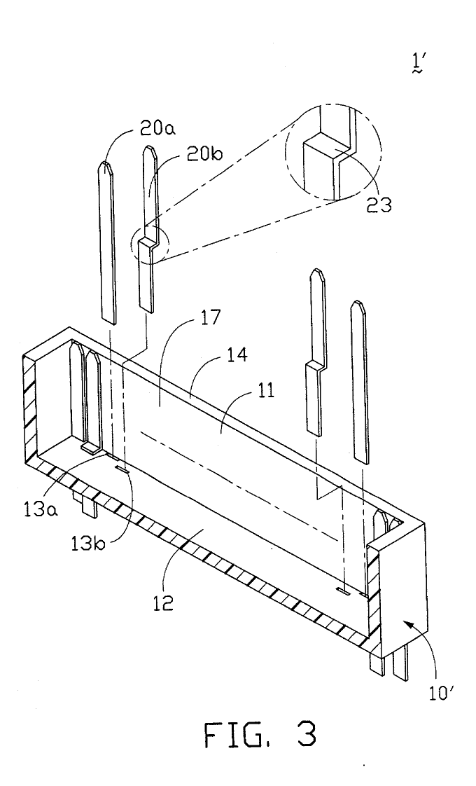

Referring to FIG. 3, an electrical connector in accordance with a second embodiment of the present invention includes a housing 10′ and a plurality of contacts 20a, 20b. A bottom wall 12 of the housing 10′ defines stagger elongate pin holes 13a, 13b in each side thereof. The pin holes 13a, 13b may be triangular (see FIG. 4) or other shaped. Each of side walls 14′ extending from the bottom wall 12 has a planar inner surface 17. Each contact 20b has a shoulder 23. The contacts 20a extend through the pin holes 13a and abut against the inner surface 17 of the side wall 14. The contacts 20b extend through the pin holes 13b and abut against the inner surface 17 of the side wall 14 with the shoulder 23 thereof being supported by the bottom wall 12. Thus, the pin holes 13a, 13b and contacts 20a, 20b are compact thereby maximizing the capacity of information transmission of the connector 1′. Furthermore, the configuration of the electrical connector 1′ is miniaturized.

It is noted that the traditional high density staggered arrangement for the contact tails may have limitations due to tiny dimension of the corresponding core pins, which form the pin holes in the housing, tending to break. Oppositely, using the large dimensioned core pins to form such pin holes may result in interference between every adjacent two pin holes because of fine pitch arrangement thereof. Thus, using the alternating triangular core pins to form the corresponding alternating triangular pin holes for retaining the corresponding staggered contact tails therein, may comply with the fine pitch requirement while still maintaining the sufficient partition wall thickness between every adjacent two pin holes for strength of the whole connector housing. Understandably, the pin holes with other shapes which are arranged in an alternating/complementary manner to hold the staggered contact tails is included in this invention.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. An electrical connector comprising:
a housing having a bottom wall, longitudinal side walls and end walls extending from peripheral of the bottom wall, a plurality of pin holes defined in staggered arrangement in the bottom wall; and
a plurality of contacts received in the pin holes of the housing.

2. The electrical connector as claimed in claim 1, wherein each of the pin holes is substantially elongate.

3. The electrical connector as claimed in claim 1, wherein each of the pin holes is substantially triangular.

4. The electrical connector as claimed in claim 1, wherein each of the contacts comprises a base portion securely engaged in the pin holes, a contact portion and a tail portion extending over the bottom wall.

5. The electrical connector as claimed in claim 4, wherein a plurality of ribs, on which the contact is securely supported, extend alternatively over inner surface of the side walls of the housing.

6. The electrical connector as claimed in claim 1, wherein the contacts comprise vertical contacts and bended contacts, wherein each of the vertical contacts comprises a base portion securely received in the pin hole, a contact portion supported by the side walls and a tail portion extending over the bottom wall, and wherein each of the bended contacts comprises a contact portion supported by the side walls, a tail portion extending over the bottom wall and a shoulder connected between the contact portion and the tail portion and supported by the bottom wall.

7. An electrical connector comprising:
a housing defining a bottom wall, longitudinal side walls, and end walls extending from peripheral of the bottom wall;
a plurality of pin holes defined in the bottom wall;
a plurality of ribs formed alternatively along inner surfaces of the side wall thereby defining plateaus and valleys thereover, each plateau and valley being arranged corresponding to the pin holes; and
a plurality of contacts assembled to the housing and including a base portion securely engaged in the pin holes, and contact portions supported by the plateaus and the valleys, respectively, and tail portions extending over the bottom wall.

8. An electrical connector comprising:
an insulative housing;
at least one row of pin holes arranged in a lengthwise direction of the housing, said pin holes being arranged in an alternating manner so as to have the adjacent two pin holes complementary with each other along said lengthwise direction; and
at least one row of pins respectively disposed in said pin holes with tails extending out of the housing in a staggered manner along said lengthwise direction.

9. The connector as claimed in claim 8, wherein the every adjacent two pin holes are reversely arranged with each other.

10. The connector as claimed in claim 8, wherein a partition wall between the every adjacent two pin holes extends obliquely relative to said lengthwise direction.

11. The connector as claimed in claim 8, wherein said pin holes are triangular.
